(19) United States
(12) Patent Application Publication
(10) Pub. No.: US 2003/0106493 A1
(43) Pub. Date: Jun. 12, 2003

(54) Shield for a robot arm

(76) Inventors: Joann F.C. Christian, New Castle, DE (US); Douglas Conlin, Wilmington, DE (US)

Correspondence Address: Connolly Bove Lodge & Hutz LLP, P.O. Box 2207, Wilmington, DE, 19899-2207, US

(21) Appl. No.: 10/006,028

(22) Filed: Dec. 7, 2001

(51) Int. Cl. B05C 11/11

(52) U.S. Cl. 118/504

(57) ABSTRACT

A shield for covering a robot arm such as in a paint spray booth is made of a porous foam material having high flow permeability. The shield includes a pair of integral straps which are connected to each other when the shield is mounted around the robot arm solely by a single set of fasteners. One end of the shield includes a cutout or dipped in portion for disbursing paint.

### BACKGROUND OF THE INVENTION

The present invention is directed to a shield for a robot arm and more particularly for a robot used in a paint spray booth, such as in a vehicle assembly line. U.S. Pat. No. 6,082,290 discloses a robot having a cover member assembly at its wrist joint. The assembly includes cover members which interlock to seal out paint while allowing a full range of motion. Copending application Ser. No. 09/307,237, filed May 7, 1999, relates to a variation of that invention wherein a foam sleeve is mounted over the semi-rigid cover member assembly to protect the more expensive cover member assembly.

It would be desirable if some form of shield could be provided to protect a robot arm, particularly at the joint. It would also be desirable if such a shield could be used in combination with the robot cover assembly and/or foam sleeve as described above.

### SUMMARY OF THE INVENTION

An object of this invention is to provide a shield for a robot arm.

A further object of this invention is to provide such a shield which could be manufactured at low cost and yet be effective in operation in protecting covering structure at the joint of a robot arm.

In accordance with this invention a shield for a robot arm is made from a porous foam material having an elongated shape with integral straps extending outwardly from its opposite sides so that the body member could be wrapped around a robot arm and then maintained in a wrapped condition by complementary fasteners on the straps. The robot arm could initially have a semi-rigid cover assembly at its joint which is then provided with an outer foam sleeve and the shield could be mounted over the foam sleeve.

In accordance with one aspect of the invention the porous foam material of the shield is made with high flow permeability having a significant amount of open area.

In accordance with a further aspect of this invention the complementary fasteners on the straps comprise the sole fastening structure so that the shield could be easily removed by simple finger pressure, particularly where snap fasteners are used as the fastening structure.

In accordance with a still further aspect of this invention one end of the shield has curved corners which meet to form a dipped in or converging edge formation to facilitate dispersing any paint spray that might otherwise accumulate.

### THE DRAWINGS

FIG. 1 is a top plan view of a shield for a robot arm in accordance with this invention in its open condition;

FIG. 2 is a side elevational view of the shield shown in FIG. 1;

FIGS. 3 and 4 are rear and front elevational views respectively of the shield shown in FIGS. 1-2;

FIG. 5 is a side elevational view showing the shield of FIGS. 1-4 assembled around a sleeve on a robot arm in accordance with this invention;

FIG. 6 is an end elevational view of the shield assembly shown in FIG. 5;

FIG. 7 is a plan view of the shield shown in FIGS. 1-4 in its assembled condition;

FIG. 8 is a view similar to FIG. 5 showing the shield in its mounted condition in a plan view thereof;

FIG. 9 is a top plan view showing a typical prior art foam pad; and

FIG. 10 is a view similar to FIG. 9 showing a highly porous foam material as preferably used in the shield of this invention.

### DETAILED DESCRIPTION

The present invention is directed to a shield for protecting the joint of a robot arm, particularly where the arm is mounted to the paint spray nozzle or gun. In the preferred practice of the invention the joint would initially be covered by a semi-rigid cover member assembly of the type described in U.S. Pat. No. 6,082,290, all of the details of which are incorporated herein by reference thereto. In general, such cover member assembly includes a pair of cover members made of semi-rigid non-bellows type material which are interlocked in such a manner as to allow a full range of motion. The provision of the cover assembly at the joint functions to seal out paint while allowing the full range of motion of the robot and paint spray nozzle in order to apply paint to, for example, a vehicle in a paint spray booth of a vehicle assembly line.

In order to minimize down time that would be required for replacing the cover member assembly it has been proposed in copending application Ser. No. 09/307,237, filed May 7, 1999, all of the details of which are incorporated herein by reference thereto, to provide a sleeve preferably made of a foam material over the inner cover member assembly. Such sleeve could also be applied directly over the joint without an inner cover assembly. In use, such sleeve would also require replacement at various stages of operation. The present invention is directed to providing a shield over the sleeve so as to minimize down time and replacement costs. For example, the invention could be practiced by providing an arrangement which insulates and absorbs overspray during use of a robot and paint spray gun. By providing a shield, one shield would have the affect of replacing three sleeves. This could minimize down time by over one-half. In addition, the cost of a shield could be less than half the cost of a sleeve thereby also reducing maintenance costs. Further, as later described, the ease in removing the shield as compared to the manipulations required for removing a sleeve would also add to efficiency.

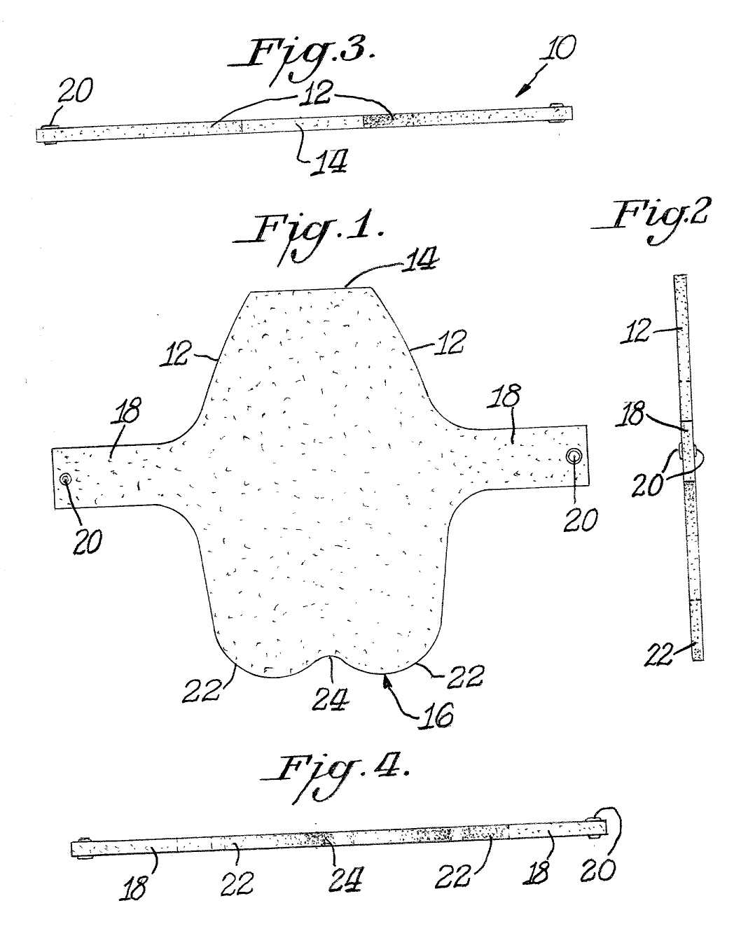

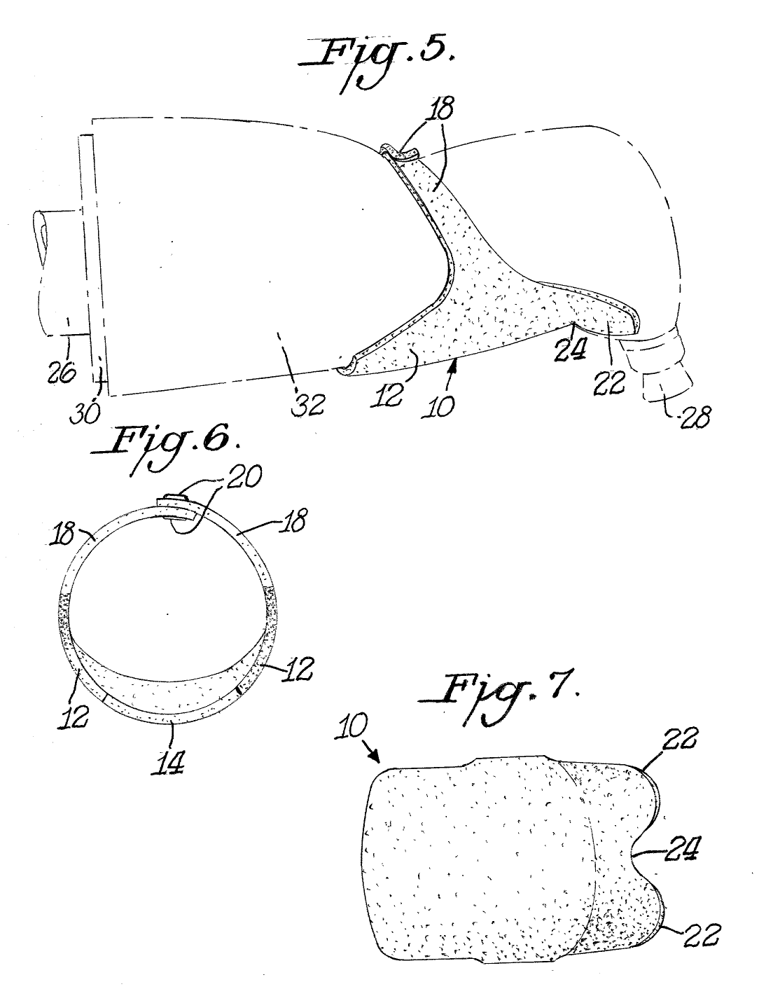

FIGS. 1-4 illustrate a shield 10 in accordance with this invention. As shown therein shield 10 is a body member made of a porous foam material. The body member is of elongated shape having opposite sides 12,12 and intermediate ends 14,16. An integral strap 18,18 extends outwardly from each of the sides 12,12. The straps 18,18 are located generally along the central portion of the length of each side 12,12 although slightly closer to the end 14. Each strap 18 includes a fastener 20. The fasteners 20,20 are complementary fasteners and preferably are snap fasteners so that the flexible shield could be wrapped around a robot arm and maintained in the closed wrapped condition by snapping the fasteners together as shown, for example, in FIG. 6.

As shown in FIG. 1 the sides 12,12 are generally of a smooth curved shape merging into the straps 18,18 and into the ends 14,16. Thus, the straps 18,18 taper over at least a portion of their length such as at the portion which merges outwardly from the sides 12,12. The sides 12,12 merge into end 16 by a pair of curved corners 22,22. The curved corners are joined together in the generally central portion 24 of end 16. Central portion 24 is a reverse curve opposite the curves 22,22 to form a dipped in portion having converging edges.

While it is preferable that end 16 includes the curved shoulders 22 and central cut out or dipped portion 24 the opposite end 14 could be of any suitable shape such as straight line shape as illustrated.

Shield 10 would be made of a size suitable for fitting around the robot arm at the joint with the spray nozzle. If a cover assembly and a sleeve are provided then the shield would have to be made sufficiently large to accommodate the cover member assembly and sleeve. Conversely, if the cover member and/or sleeve were omitted then the shield could be made smaller. An example of suitable dimensions would be for shield 10 to have an overall width from one end of strap 18 to the other of about 21¾ inches and an overall length of about 13½-15¼ inches. The curved edge 16 could be about 7 inches wide while the straight edge 14 could be about 5-5½ inches wide. Because the side edges 12,12 are curved the width between the edges varies, but could generally be about 9½ inches. Straps 18,18 could be about 2¼ inches wide and about 3¼ inches wide at its point of connection with the sides 12,12.

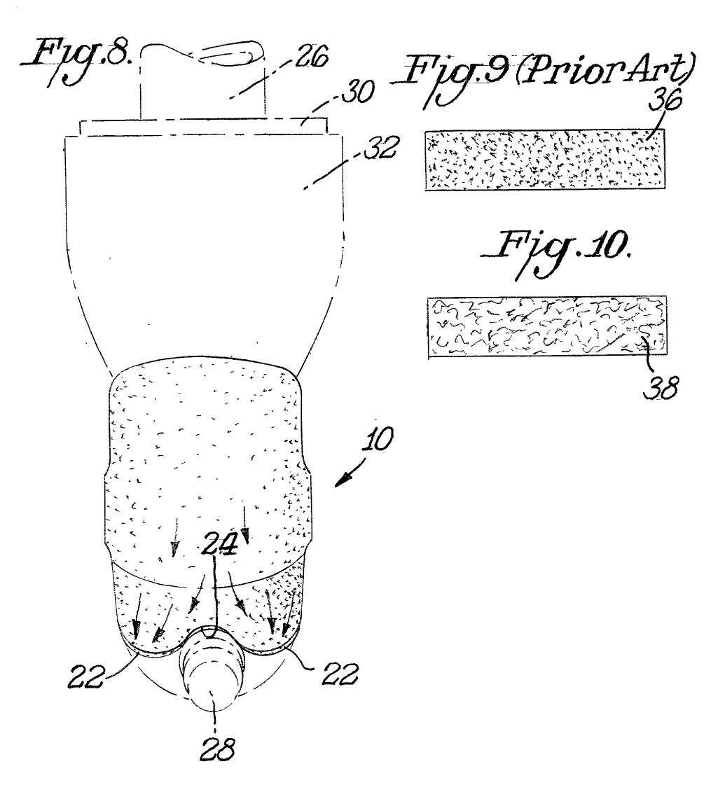

FIGS. 5 and 8 illustrate the shield 10 in its mounted condition. As shown therein shield 10 is mounted at the joint of a robot arm 26 and gun head or paint spray nozzle 28. In a preferred practice of this invention the joint is initially protected by a cover member assembly 30 as described in U.S. Pat. No. 6,082,290. The cover member assembly 30 is then covered with a protective sleeve 32 preferably made of a foam material as described in application Ser. No. 09/307,237. When in the assembled condition shown in FIGS. 5-8 the shield 10 is maintained wrapped around the robot arm (such as by being disposed over sleeve 32) and held in the closed wrapped condition solely by the one set of fasteners 20,20 which engage each other at the overlapped portion of the straps 18,18 as best shown in FIGS. 5 and 6. Because of the shape of shield 10 and particularly its curved edges, when the fasteners 20,20 are secured together sufficient tension is created at the joint between the robot arm and the gun head that a tight fit is created solely by the one fastening location of fasteners 20,20 in that the straps 18,18 tend to pull the shield toward the secured location creating a peripheral tension which is sufficient to prevent the shield from flapping. When it is desired to remove the shield all that need be done is to unsnap the fasteners 20,20 which could be done by an operator with the use of only one hand. This is an important consideration in that in such paint spray booths operators frequently wear sticky rubber gloves and it would be desirable to minimize the amount of manipulations required for removal of the shield.

As can be seen by comparing FIGS. 1-5 shield 10 in its open unmounted condition has its straps 18,18 generally in line with each other. See FIG. 1. When mounted on the robot arm, however, the tension resulting from accommodating the shape of the robot arm joint is such that the straps 18,18 assume an angled non-perpendicular condition. An indent also results where central dipped in portion 24 meets the joint at the nozzle or gun head 28. See FIG. 5.

Although the invention could be practiced with any suitable type of fasteners, snap fasteners are preferred over other types of fasteners such as hook and loop fasteners which have hair like structure that make it unsuitable for a shield in a paint spray booth. The removal of the shield is easily accomplished by a finger pull at the snap which is the weakest area of the tensioned shield in its mounted condition. Thus, the removal of the shield is in such a manner as to minimize setting off microparticles of dirt or paint into the air that might otherwise occur if a cover member were torn off or otherwise removed.

As best shown in FIG. 8 the central portion 24 of shield 10 generally conforms in shape to the gun head 28. As a result, the dipped in or cut out portion 24 causes paint to disperse away from the gun head as indicated by the arrows of FIG. 8.

A further feature of this invention is in the use of a highly porous material for shield 10. FIG. 9, for example, shows a conventional foam material 36 which might be used as the material of sleeve 32. Such material while made of a foam has a relatively small open area such as 65 pores per inch. FIG. 10, however, illustrates a foam material 38 which is preferably used for making the shield 10 in accordance with this invention. As shown therein the material 38 is highly porous having a very high flow permeability creating substantial open area or open volume from surface to surface. For example, the porous size would be increased so that material 38 would have from 25 to 55 pores per inch of larger size pores than the 65 pores per inch in the type of foam material 36 shown in FIG. 9. More preferably, the pores would be in a range of 25 to 40 per inch and most preferably about 30 pores per inch. The pore size might also be considered with respect to the open area that results from the high flow permeability foam of this invention. One type of comparison would be to hold a conventional foam, such as foam 36, to the light and the open area would be so small that there would be no clear path of light through the foam 36. With the foam 38, however, it is possible not only for light to pass through the foam, but also for a person to actually see through the foam. There should be, for example, at least 10 percent open area in the material used for shield 10. More preferably there should be at least 25 percent open area and even more preferably at least 50 percent open area. The invention could be practiced with even higher amounts of open area such as 75 percent. Use of such a high flow permeability material would not be obvious as a cover for a robot in a paint spray booth since one would ordinarily expect that by increasing the open area there would be a loss in electrical insulation. Surprisingly, however, the high flow permeability foam not only has sufficient electrical insulation, but also has greater absorability than conventional type foams such as foam 36 of FIG. 9.

Any suitable foam material meeting the requirements of paint spray booths could be used in accordance with this invention. Such materials could include, for example, reticulated polyester foam.

It is to be understood that while the present invention involves different aspects, the invention could be practiced where one or more of these aspects are not included. Thus, for example, the shield could be used having only the high flow permeability aspect and/or the single set of fastener aspect and/or the cutout end edge to disburse paint aspect.

It is also to be understood that while the invention is preferably practiced where the shield 10 is mounted over a protective foam sleeve 32 which in turn would be mounted over a semi-rigid cover member assembly 30 the invention could be practiced by omitting the cover member assembly and/or sleeve.

What is claimed is:

1. A shield for a robot arm comprising a body member made of a porous foam material, said body member having opposite sides and intermediate ends, an integral strap extending outwardly from each of said sides, said body member being bendable whereby said body member may be wrapped around a robot arm and whereby said straps may overlap each other, complementary fasteners on said straps to secure said straps together and maintain said body member wrapped around the robot arm, and said porous foam having high flow permeability with the pores creating an open area from surface to surface of at least 10%.

2. The shield of claim 1 wherein said foam has from 25 to 55 pores per inch.

3. The shield of claim 1 wherein said foam has sufficient open area to permit the passage of light directly therethrough.

4. The shield of claim 1 wherein said foam has about 30 pores per inch.

5. The shield of claim 1 wherein said straps taper inwardly from said sides over at least a portion of the length of said straps, said straps being located inwardly of said ends at a generally central portion of said sides, and said complementary fasteners being the sole fastening structure for maintaining said shield in a closed wrapped condition.

6. The shield of claim 5 wherein said fasteners are snap fasteners.

7. The shield of claim 6 wherein one of said ends is connected to said sides by curved corners merging from each of said sides to said one end, each of said curved corners continuing to curve inwardly toward the center of said body member, and said curved corners being connected together generally centrally of said one end whereby said one end has an edge which has a dipped in portion having converging edges located generally midway of said one end.

8. The shield of claim 7 wherein said dipped in portion is a curved edge opposite the curvature of said curved corners.

9. The shield of claim 7 in combination with a foam sleeve, and said shield being mounted over said sleeve.

10. The combination of claim 9 in further combination with a semi-rigid cover member assembly, and said foam sleeve being mounted over said cover member assembly.

11. The shield of claim 1 wherein one of said ends is connected to said sides by curved corners merging from each of said sides to said one end, each of said curved corners continuing to curve inwardly toward the center of said body member, and said curved corners being connected together generally centrally of said one end whereby said one end has an edge which has a dipped in portion having converging edges located generally midway of said one end.

12. The shield of claim 11 wherein said dipped in portion is a curved edge opposite the curvature of said curved corners.

13. The shield of claim 1 in combination with a foam sleeve, and said shield being mounted over said sleeve.

14. The combination of claim 13 in further combination with a semi-rigid cover member assembly, and said foam sleeve being mounted over said cover member assembly.

15. The combination of claim 14 in combination with a robot having a robot arm connected to a gun head at a joint, and said cover assembly being of non-bellows formation mounted at said joint.

16. A shield for a robot arm comprising a body member made of a foam material, said body member having opposite sides and intermediate ends, an integral strap extending outwardly from each of said sides, said body member being bendable whereby said body member may be wrapped around a robot arm and whereby said straps may overlap each other, complementary fasteners on said straps to secure said straps together and maintain said body member wrapped around the robot arm, said straps tapering inwardly from said sides over at least a portion of the length of said straps, said straps being located inwardly of said ends at a generally central portion of said sides, and said complementary fasteners being the sole fastening structure for maintaining said shield in a closed wrapped condition.

17. The shield of claim 16 wherein said straps are located slightly further from one of said ends.

18. The shield of claim 17 wherein said sides have a shape which is a continuous smooth curve which merges into said straps.

19. The shield of claim 16 wherein one of said ends is connected to said sides by curved corners merging from each of said sides to said one end, each of said curved corners continuing to curve inwardly toward the center of said body member, and said curved corners being connected together generally centrally of said one end whereby said one end has an edge which has a dipped in portion having converging edges located generally midway of said one end.

20. The shield of claim 19 in combination with a foam sleeve, and said shield being mounted over said sleeve.

21. The combination of claim 20 in further combination with a semi-rigid cover member assembly, and said foam sleeve being mounted over said cover member assembly.

22. The shield of claim 16 in combination with a foam sleeve, and said shield being mounted over said sleeve.

23. The combination of claim 22 in further combination with a semi-rigid cover member assembly, and said foam sleeve being mounted over said cover member assembly.

24. The combination of claim 23 in combination with a robot having a robot arm connected to a gun head at a joint, and said cover assembly being of non-bellows formation mounted at said joint.

25. A shield for a robot arm comprising a body member made of a porous foam material, said body member having opposite sides and intermediate ends, an integral strap extending outwardly from each of said sides, said body member being bendable whereby said body member may be wrapped around a robot arm and whereby said straps may overlap each other, complementary fasteners on said straps to secure said straps together and maintain said body member wrapped around the robot arm, one of said ends being connected to said sides by curved corners merging from each of said sides to said one end, each of said curved corners continuing to curve inwardly toward the center of said body member, and said curved corners being connected together generally centrally of said one end whereby said one end has an edge which has a dipped in portion having converging edges located generally midway of said one end.

26. The shield of claim 25 wherein said dipped in portion is a curved edge opposite the curvature of said curved corners.

27. The shield of claim 26 wherein said sides have a shape which is a continuous smooth curve which merges into said straps.

28. The shield of claim 25 in combination with a foam sleeve, and said shield being mounted over said sleeve.

29. The combination of claim 28 in further combination with a semi-rigid cover member assembly, and said foam sleeve being mounted over said cover member assembly.

30. The combination of claim 29 in combination with a robot having a robot arm connected to a gun head at a joint, and said cover assembly being of non-bellows formation mounted at said joint.
